(19) United States
(12) Patent Application Publication
(10) Pub. No.: US 2008/0201223 A1
(43) Pub. Date: Aug. 21, 2008

(54) PRODUCTS AND PROCESSES FOR PROVIDING INFORMATION SERVICES

(76) Inventor: Howard W. LUTNICK, New York, NY (US)

Correspondence Address: DEAN P. ALDERUCCI, CANTOR FITZGERALD, L.P., 110 EAST 59TH STREET (6TH FLOOR), NEW YORK, NY, 10022, US

(21) Appl. No.: 11/857,915

(22) Filed: Sep. 19, 2007

Related U.S. Application Data
(60) Provisional application No. 60/826,181, filed on Sep. 19, 2006.

(51) Int. Cl. G06Q 30/00

(52) U.S. Cl. 705/14

(57) ABSTRACT

Methods and system are provided herewith for providing information services. A data service in according with the methods and systems disclosed herein may provide content for the data service and/or may provide content to subscribers via the service and the content provider may provide a credit or other benefit to the content provider.

The present application claims priority to U.S. Provisional Application No. 60/826,181 entitled PRODUCTS AND PROCESSES FOR GA PROVIDING INFORMATION SERVICES, filed on Sep. 19, 2006, which is hereby incorporated herein by reference.

### BRIEF DESCRIPTION OF THE DRAWINGS

The accompanying drawings are not intended to be drawn to scale. In the drawings, each identical or similar component that is illustrated in various figures is represented by a like numeral. For purposes of clarity, not every component may be labeled or act identified in every drawing. In the drawings:

FIG. 1 shows a computer system arrangement; and

FIG. 2 shows an example process.

### DETAILED DESCRIPTION

The following sections provide a guide to interpreting the present application.

### I. Terms

The term “product” means any machine, manufacture and/or composition of matter, unless expressly specified otherwise. The term “process” means any process, algorithm, method or the like, unless expressly specified otherwise. Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise. A reference to “another embodiment” in describing an embodiment does not imply that the referenced embodiment is mutually exclusive with another embodiment (e.g., an embodiment described before the referenced embodiment), unless expressly specified otherwise. The terms “including”, “comprising” and variations thereof mean “including but not limited to”, unless expressly specified otherwise. The terms “a”, “an” and “the” mean “one or more”, unless expressly specified otherwise. The term “plurality” means “two or more”, unless expressly specified otherwise.

The term “herein” means “in this patent application, including anything which may be incorporated by reference”, unless expressly specified otherwise. The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”.

The term “represent”, “indicate”, and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms means “that is”, and thus limits the term or phrase it explains. For example, in the sentence “the computer sends data (i.e., instructions) over the Internet”, the term “i.e.” explains that “instructions” are the “data” that the computer sends over the Internet.

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, predicting, guessing and the like. The term “determining” does not imply that mathematical processing must be performed, and does not imply that numerical methods must be used, and does not imply that an algorithm or process is used. The term “determining” does not imply that any particular device must be used. For example, a computer need not necessarily perform the determining.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (I) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### IV. Disclosed Examples And Terminology Are Not Limiting

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. 5 1.72(b). Headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### V. Computing

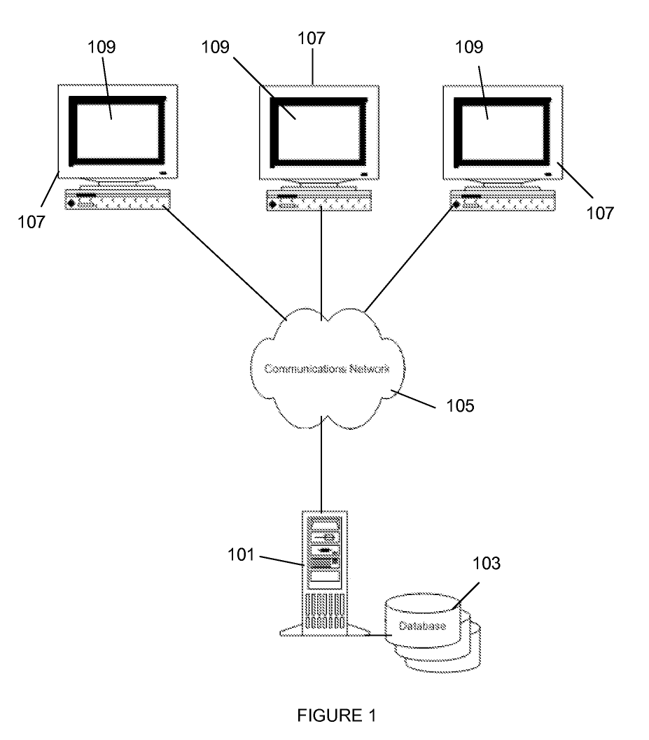

It will be readily apparent to one of ordinary skill in the art that the various processes described herein may be implemented by, e.g., appropriately programmed general purpose computers and computing devices such as is shown in FIG. 1. Typically a processor (e.g., one or more microprocessors, one or more microcontrollers, one or more digital signal processors) will receive instructions (e.g., from a memory or like device), and execute those instructions, thereby performing one or more processes defined by those instructions.

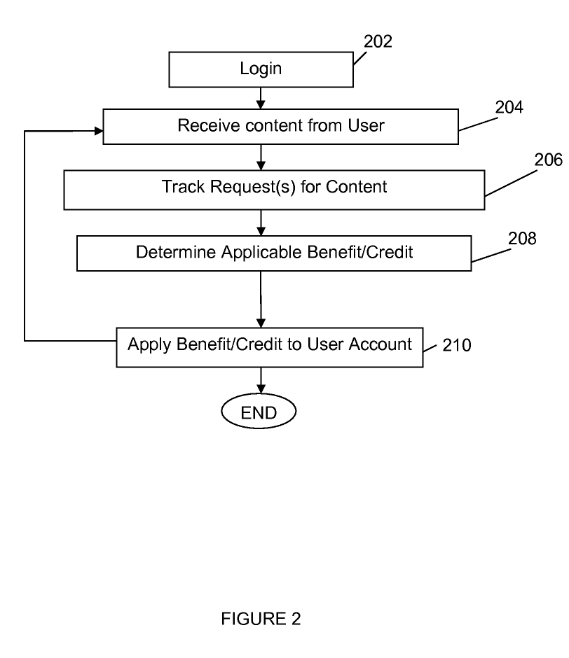

FIG. 1 shows an example computer system arrangement that may be found in some embodiments. As shown, a server computer 101 may execute one of more processes implementing one or more features disclosed herein. The server computer may access a database 103 containing information about user or subscriber accounts, account balances, content for data services, etc. The server computer 101 may be coupled through a communication network 105 (e.g., the Internet and/or one or more LANs) to a remote computer system, such as a personal computer 107 of a customer. The personal computer 107 may execute one of more processes implementing one or more features disclosed herein. For example, the personal computer 107 may execute a web browser that may access a web page maintained by the server computer 101. Such a web page may be displayed through monitor of other display device to prove the user with an interface 109. Together, the personal computer 107 and server computer 101 may enable one or more of the features described herein. A computer arrangement such as that illustrated in FIG. 1 may perform a process such as that illustrated in FIG. 2. It should be recognized that FIG. 1 is given as an example only, and that other embodiments may include any arrangement of devices, including mobile devices, multiple servers or personal computers, and no central servers at all.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus can include, e.g., a processor and those input devices and output devices that are appropriate to perform the process.

Further, programs that implement such processes (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCPI/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel© Pentium-type or Core-type processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VI. Continuing. Applications

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

### VII. 35 U.S.C. § 112, Paragraph 6

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of’ or the phrase “steps of’ in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

### VIII. Disclaimers

Numerous references to a particular embodiment does not indicate a disclaimer or disavowal of additional, different embodiments, and similarly references to the description of embodiments which all include a particular feature does not indicate a disclaimer or disavowal of embodiments which do not include that particular feature. A clear disclaimer or disavowal in this patent application shall be prefaced by a phrase such as “in all embodiments”.

### IX. Incorporation by Reference

Any patent, patent application or other document referred to herein is incorporated by reference into this patent application as part of the present disclosure, but only for purposes of written description in accordance with 35 U.S.C. § 112, paragraph 1 and enablement in accordance with 35 U.S.C. § 112, paragraph 1, and should in no way be used to limit, define, or otherwise construe any term of the present application where the present application, without such incorporation by reference, would not have failed to provide an ascertainable meaning, but rather would have allowed an ascertainable meaning for such term to be provided. Thus, the person of ordinary skill in the art need not have been in any way limited by any embodiments provided in the reference.

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### XI. Various Embodiments

Methods and system are provided herewith for providing information services. A data service (e.g., similar to Reuters, Lexis-Nexis, etc.) in according with the methods and systems disclosed herein may provide content for the data service and/or may provide (consumer) content to subscribers via the service. Referring to FIG. 2, a method according to at least one embodiment of the methods disclosed herein begins with a user, e.g., a subscriber and/or content provider, logging into the system at 202. The user may access data provided by the information service thereafter. Various types of content may be available on the data service (and therefore content which entities can contribute, as discussed herein), which include: video, audio/podcast, transaction data (e.g., bids, offers, requests for quotes on financial instruments such as stocks or bonds), chat rooms, analysis, research, magazine and other articles, rumors, market data, news, modeling systems, advertising, games, weather reports and forecasts, “cleaned” data (e.g., corrected/improved versions of others' content), etc. In an embodiment, the user may provide content to the information service, in which instance, the service receives content at 204. The service preferably tracks at 206, for at least the content provided by the user, data relevant to computing a credit to the content provider.

In an embodiment, users are charged a fee (e.g., $400 per month per user) for the data service and also receive a credit for content they provide to the service. The service provider may also apply a maximum credit for any particular subscriber for the content provided. For example, the credit for providing content may be no more than half of the normal subscription fee. In such an example, where the fee is $400 per month per user, the credit could be up to $200 per month per user. Thus a user that contributes sufficient content could pay only $200 (=$400−$200) per month for subscribing to the data service. The maximum credit may be some other amount, up to and including the full subscription fee as well as an amount exceeding the full subscription fee.

The credit may be structured to provide a larger credit for certain content than for other content. For example, content provided by the subscriber, or generally the content provider, at a first instance may receive a credit in an amount higher than content provided at a later instance. The reverse may similarly be provided. That is, the higher credit may be given for subsequent content. For example, a first instance of content from the content provider may be worth $10, a second instance $20, etc., all the way up to any limit.

The amount of the credit may vary based on the type or quality of the content. For example, readily available content, e.g., from multiple subscribers or from non-subscribers, may be worth less than content not readily available, e.g., except from one or few subscribers and/or not available from non-subscribers (e.g., publicly). The amount of the credit may be limited to the cost of the content had the content been procured from another source. A nominal credit may apply in these instances for the content provider's effort. The credit may be structured in any one or more of a variety of ways. For instance, a portion of the aggregation of all subscription fees or revenue may be paid to entities that provide content. For example, 5% of all subscription fees may be allocated to a pool, and the pool is distributed to entities that provide content to the data service. The percentage of the subscription fee allocated to the pool may further be allocated to individual content providers based on the individual provider's contribution to the content provided by the pool. In an embodiment, a first entity can “clean” the content contributed by a second entity, the first entity can receive compensation (e.g., a commission that is based on, e.g., a portion of, the compensation provided to the second entity for accesses of that data). The credit to an entity in return for contribution of content may also be based on:
what type of content is contributed,
how much content is contributed,
how many entities access the contributed content,
how many accesses of the contributed content there are,
how much money entities pay to access the contributed content, and/or
whether that entity has paid a fee.

Accordingly, the amount of credit or other benefit may be determined at 208 and the benefit may be applied to the content provider account at 210. Content providers may be provided with an interface that allows users to determine or otherwise access the credit information relevant to the user. For example, the interface may provide an indication of the content provided, the type of content, how may times the content has been accessed, money paid to access the data, the provider's portion thereof, accumulated credits, account balances, etc. The data may be displayed in a consumption meter, e.g., pie chart, text) can display content contributed, and how much credit (e.g., as a percentage of the total credit receivable) is due from the contributed content.

There may be limitations on who can contribute data to the data service. For example, there may be a restriction that only entities who are subscribers to the data service or only entities that pay the full fee (e.g., $400 per month) can contribute data. Limitations may also be specific to the data or to some other criteria. For instance, credit may only be given to entities having authority to provide the data. For example, for copyrighted content, credit may only be given to the copyright owner or a licensee thereof. If data theft or other violation is detected, an alert may be sent to the parties involved (e.g., entity that contributed content).

There can be a benefit (besides a credit) provided to entities that provide content to the data service. For example, an entity that provides content to the data service in the context of a trading system, e.g., a financial instrument trading system, can be provided with lower brokerage commissions or no brokerage commissions, or other fees. The reduced/eliminated brokerage commissions or other fees provided that entity “consumes” data (i.e. accesses data) that is related to the brokerage. For example, an entity that provides content to the data service can be provided with reduced/eliminated brokerage commissions on a trade of a US Treasury bill provided that entity “consumes” data that relates to the US Treasury market. The same concepts discussed herein may be applied to a revenue sharing arrangement. That is, rather than giving a credit against a subscription fee, credit may be applied to apportion a portion of, e.g., advertising or other revenue, derived from the content. In an embodiment, the content provider is provided with equity in the service provider. For example, a company which includes the data service could be taken public. Subscribers and/or entities that provide content can be provided with equity in the company, e.g., in the form of shares of the company at the IPO or any time thereafter.

The data service may be accessible via a web interface, and/or via another program (e.g., a customer application, RSS data reader). There can be an API to allow a program to be written to access the content. An entity's access to certain data (or all data) on the data service can be contingent on one or more of the following:
that entity having contributed data to the data service,
what type of content is contributed,
how much content is contributed,
how many entities access the contributed content,
how many accesses of the contributed content there are,
how much money entities pay to access the contributed content, and/or
whether that entity has paid a fee.

In an embodiment, content may be rated based on accesses (e.g., number of entities accessing the data, number of accesses per time). The rating can be applied currently and historically (e.g., most frequently accessed today, most frequently accessed this year). Similarly, the accesses and/or the rating of any content can be displayed (e.g., an X-Y plot over time). A “ratings page” can show top rated content (overall, by category)—this would help those interested in being guided to top content. There can be different ratings in different categories of content (e.g., most popular financial content, most popular analysts reports, etc.) Any particular content can fall into one or more categories.

In an embodiment, an entity that submits a “good” bid or offer can receive ratings/points. A bid or offer may be considered “good” if it is (1) aggressive with comparable bids/offers, (2) better than comparable bids/offers, (3) results in a match within a predetermined time. Points can be assigned to content based on the content's ratings. The points assigned to certain contributed content can be used to calculate the credit due an entity that contributes the content (e.g., the credit itself, a bonus payment in addition to the credit, etc.) Points can be deducted based on poor performance of the content (e.g., less than a predetermined frequency of accesses by others).

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the scope of instant invention. Accordingly, the foregoing description and drawings are by way of example only.

What is claimed is:

1. A method, comprising
a. receiving a fee from at least one user;
b. providing content to the users from whom a fee is received;
c. receiving content from at least one user from whom a fee is received; and
d. providing a benefit to the users from whom content is received based at least in part on the content received from the user.
e.

2. The method of claim 1, wherein the benefit is a credit against the fee received from the user.

3. The method of claim 2, wherein the credit is a fraction of the fee received from the user.

4. The method of claim 2, where in the credit may not exceed a certain limit.

5. The method of claim 1, wherein c) comprises receiving content from at least one user from whom a certain type of fee is received.

6. The method of claim 5, wherein the fee is a subscription fee.

7. The method of claim 5, wherein the fee is a maximum fee.

8. The method of claim 1, wherein the content is selected from the group consisting of: video, audio, podcast, transaction data, chat rooms, analysis, research, articles, rumors, market data, news, modeling systems, advertising, games, weather reports and forecasts, and “cleaned” data.

9. The method of claim 1, further comprising e) cleaning the content received from users.

10. The method of claim 1, further comprising e) sending the content to an entity to be cleaned and f) receiving the cleaned content from said entity.

11. The method of claim 1, further comprising e) displaying the content.

12. The method of claim 1, further comprising e) receiving ratings of the content and f) displaying the received ratings.

13. A method, comprising
a. receiving content from at least one user;
b. providing a benefit to the users from whom content is received based at least in part on the content received from the user; and
c. providing content to the users only if a condition is met.
d.

14. A method, comprising
a. paying a fee;
b. viewing content in return for paying the fee;
c. providing content in return for paying the fee; and
d. receiving a benefit based at least in part on the content provided.

15. A method, comprising
a. providing content;
b. receiving a benefit based at least in part on the content provided; and
c. viewing content only if a condition is met.
